(19) United States
(12) Patent Application Publication
(10) Pub. No.: US 2005/0157368 A1
(43) Pub. Date: Jul. 21, 2005

(54) Quantum dots engineerable optical modulator transfer characteristics

(75) Inventors: Timothy A. Vang, San Dimas, CA (US); David C. Scott, Lakewood, CA (US); Elizabeth T. Kunkee, Manhattan Beach, CA (US); Wenshen Wang, Torrance, CA (US)

Correspondence Address: John A. Miller;Warn, Burgess & Hoffmann, P.C., P.O. Box 70098, Rochester Hills, MI, 48307, US

(73) Assignee: Northrop Grumman Corporation, Los Angeles, CA (US)

(21) Appl. No.: 10/758,808

(22) Filed: Jan. 16, 2004

(51) Int. Cl. G02F 1/03; G02F 1/07

(52) U.S. Cl. 359/248

(57) ABSTRACT

A Mach-Zehnder modulator that employs quantum dots to provide a push-pull drive operation. The Mach-Zehnder modulator includes a first arm having a first PIN semiconductor device and a second arm having a second PIN semiconductor device, where the intrinsic layers of the PIN devices include a quantum dot structure. A first DC bias signal is applied to one of the PIN devices, and a second DC bias signal is applied to the other PIN device. The first DC bias signal biases the intrinsic layer at an operating voltage where the index of refraction of the intrinsic layer is at a positive portion of an electro-refraction transfer function, and the second DC bias potential biases the intrinsic layer at an operating voltage where the index of refraction of the intrinsic layer is at a negative portion of the transfer function.

### BACKGROUND OF THE INVENTION

1. Field of the Invention

This invention relates generally to an optical modulator for modulating an optical signal with an RF signal, and more particularly, to a semiconductor PIN Mach-Zehnder modulator for modulating an optical signal with an RF signal and employing quantum dots in the active regions of the modulator to provide a push-pull drive operation.

2. Discussion of the Related Art

Optical communications systems typically employ an optical modulator to impress an electrical signal onto an optical carrier beam. These systems can be either analog or digital. The performance of the system significantly depends on the electrical to optical conversion transfer function of the optical modulator. In digital systems, the switching voltage (on to off) of the optical modulator must be reduced at high bit rates due to the limited voltage swing available in high-speed electronics. In analog systems, the RF gain, noise figure and spur free dynamic range of the optical system depends on the conversion efficiency and linearity of the optical modulator.

One class of modulators that operate at low modulation voltages are semiconductor modulators that employ PIN semiconductor devices where the optical wave propagates down an active region defined by the intrinsic layer in the device. An RF signal is applied to the P and N layers of the device to provide the modulation voltage across the intrinsic layer, where electrodes of the device define an RF transmission line. The RF signal alters the dielectric constant of the intrinsic layer, whose real part is the index of refraction and imaginary part is the absorption coefficient. Thus, the speed and/or the intensity of the light beam propagating through the intrinsic layer will be modulated based on the amplitude of the RF signal.

One type of optical modulator that employs PIN semiconductor devices is a Mach-Zehnder modulator (MZM). An MZM employs a Mach-Zehnder interferometer that splits the optical beam being modulated into first and second waveguide arms, where one of the waveguide arms extends through the intrinsic layer of a first PIN semiconductor device and the other waveguide arm extends through the intrinsic layer of a second PIN semiconductor device. The optical beams propagating through the two arms are then recombined in a recombiner, where the two beams constructively or destructively interfere depending on their relative phases. Thus, the manner in which the RF signal alters the index of refraction in the PIN device determines the intensity of the output beam.

In existing semiconductor modulators using either bulk or quantum well based effects, the change in transmission of the modulator is created by either electro-absorption (EA) or electro-refraction (ER). In these types of modulators, the EA or ER effects are induced by an applied electric field. The changes in EA or ER with applied field at normal operating points is typically single signed, i.e. always increasing or decreasing with field. This provides only limited capability to engineer the shape of the optical transfer function of the modulator.

Separate electrodes are coupled to the N and P layers of the first and second PIN devices to modulate the optical beam propagating therethrough. Conventional semiconductor PIN MZMs typically only use single electrode drives where the second arm of the interferometer is a passive optical waveguide. In other types of MZMs, such as lithium niobate or polymer MZMs, the advantages of employing push-pull modes of operation, known to those skilled in the art, have been demonstrated. In the push-pull configuration, typically the RF power delivered to the first arm is applied 180° out-of-phase with the RF power delivered to the second arm. In other words, by applying opposite RF signals to the PIN devices in the two arms, a doubling of the effective RF signal is provided where the RF signal has an opposite effect on the index of refraction in the intrinsic layers of the device. Thus, less RF power needs to be employed for a particular change in index of refraction. In this case, the change in phase in the two arms are equal and opposite which has the effect of increasing the amplitude modulation of the optical field and eliminating chirp.

One known way to implement an MZM is to split the input RF power using a 180° hybrid power splitter, and then apply the two RF outputs to the two arms of the modulator. However, this technique has the disadvantage of requiring broadband power splitters that must maintain strict phase control over the frequency band of interest. Because these devices use power splitting, the actual improvement in the reduction of the modulation voltage is only a factor of \sqrt{2} over that of a single arm drive modulator.

The V π of a Mach-Zehnder modulator can be decreased by a factor of \sqrt{2} or by a factor of x2, depending on whether an RF power split is required, by driving both arms of the modulator with the RF driving voltage. This improvement in V π does not necessarily decrease modulator bandwidth. To date, push-pull electrodes on PIN semiconductor modulators have been driven 180° out-of-phase, so that the retardation of the optical phase front is increased in one arm, while being decreased in the other arm. Lithium niobate modulators can employ a co-planar electrode structure which enables a single electrode push-pull operation, but PIN semiconductor modulators have not been realized with this type of co-planar electrode. When a conventional RF source is used, driving the electrodes 180° out-of-phase is not simple at high frequencies (GHz) since the methods available for producing the 180° out-of-phase RF signal are not necessarily broadband.

Most Mach-Zehnder modulator designs strive for the greatest amount of electro-refraction, since digital modulators are designed to turn an optical signal on and off. The performance of analog RF modulators, on the other hand, depend on the slope of the electro-refraction d(Δn)/dv in the intrinsic layer. In typical quantum well modulators, the electro-refractive effect is governed by the quantum confined Stark effect (QCSE), in other words, the electro-refraction is quadratic with voltage. Thus, a structure which has a large amount of electro-refraction (good for digital applications), is very similar to the quantum well structure which produces a high slope of the electro-refraction.

In both digital and analog systems, significant improvements to the modulator are needed to enable high-end systems.

### SUMMARY OF THE INVENTION

In accordance with the teachings of one embodiment of the present invention, a Mach-Zehnder modulator is disclosed that employs quantum dots to provide a push-pull drive operation. The Mach-Zehnder modulator includes a first arm having a first PIN semiconductor device and a second arm having a second PIN semiconductor device, where the intrinsic layers of the PIN devices include a quantum dot structure. The quantum dot structure provides a series of delta energy states above the band gap energy in the intrinsic layers that define the energy levels where electro-absorption occurs for a certain optical wavelength.

In one embodiment, a first DC bias signal is applied to one of the PIN devices, and a second DC bias signal is applied to the other PIN device, where the DC bias signals bias the quantum dot structures at a location relative to the delta energy states where minimal electro-absorption occurs. The first DC bias signal biases the intrinsic layer at an operating voltage where the index of refraction of the intrinsic layer is at a positive portion of an electro-refraction transfer function, and the second DC bias signal biases the intrinsic layer at an operating voltage where the index of refraction of the intrinsic layer is at a negative portion of the transfer function. Therefore, the index of refraction of the intrinsic layers of the first and second PIN devices change in opposite directions for the same RF signal in phase. In other words, the quantum dot structures in each arm of the Mach-Zehnder interferometer are matched, and are tuned separately so that for a given applied electric field, one arm implements a positive change in optical phase and the other arm implements a negative change in optical phase.

In an alternate embodiment, a selective epitaxial growth of the quantum dot structures in the intrinsic layers is provided to effect an opposite push-pull operation for the same DC potential. In other words, the quantum dot structures in the intrinsic layers are selectively grown so that the delta energy states for the devices are at different locations for the same DC potential. This allows a positive or negative change of the RF signal to have the same effect in the two arms as described above, but with the same DC operating bias.

In another embodiment, the electro-absorption effect is employed to intensity modulate the optical beam. The intrinsic layer is DC biased so that the operating voltage is positioned at a certain location relative to an energy density state. When the RF signal is applied, a rise in the bias potential causes the energy state to move away from or towards the energy state, and a fall in the RF signal potential has the opposite effect. As the energy state moves towards the absorption energy of the wavelength of the optical beam, more of the optical beam is absorbed, thus affecting its intensity.

Additional features and advantages of the present invention will become apparent from the following description and appended claims taken in conjunction with the accompanying drawings.

### BRIEF DESCRIPTION OF THE DRAWINGS

FIGS. 1(a)-1(d) show semiconductor device structures for bulk, quantum well, quantum wire and quantum dots devices, respectively;

FIGS. 2(a)-2(d) are graphs with density of states on the vertical axis and energy on the horizontal axis depicting the transition of semiconductor density of states for bulk, quantum well, quantum wire and quantum dots structures, respectively;

FIG. 3 is a graph with refractive index on the vertical axis and wavelength on the horizontal axis showing the relationship between the change in absorption Δα due to an applied electric field and the resulting change in refractive index Δn as described by the Kramers-Kronig relationship;

FIG. 4 is a perspective view of a Mach-Zehnder modulator employing quantum dots, according to an embodiment of the present invention; and

FIG. 5 is a cross-sectional view of a portion of the Mach-Zehnder modulator shown in FIG. 4.

### DETAILED DESCRIPTION OF THE EMBODIMENTS

The following discussion of the embodiments of the invention directed to a Mach-Zehnder interferometer modulator employing quantum dots to effect a push-pull operation is merely exemplary in nature, and is in no way intended to limit the invention or its applications or uses.

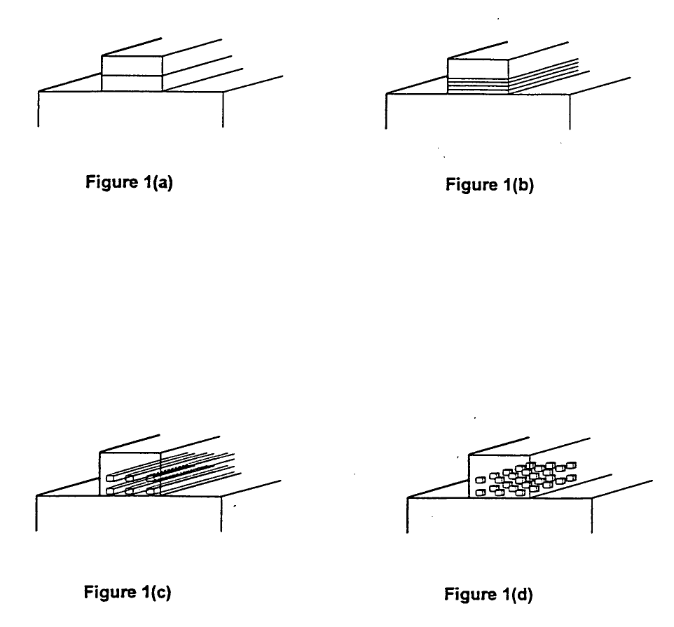

FIGS. 1(a)-1(d) show representative structures of a bulk semiconductor configuration, a quantum well semiconductor configuration, a quantum wire semiconductor configuration and a quantum dot semiconductor configuration, respectively. Quantum dots provide a well known material configuration in the field of semiconductor devices. One unique property of quantum dots includes modifying the density of states function within the quantum dot to effectively be single valued at the bound energy states of the quantum dot structure.

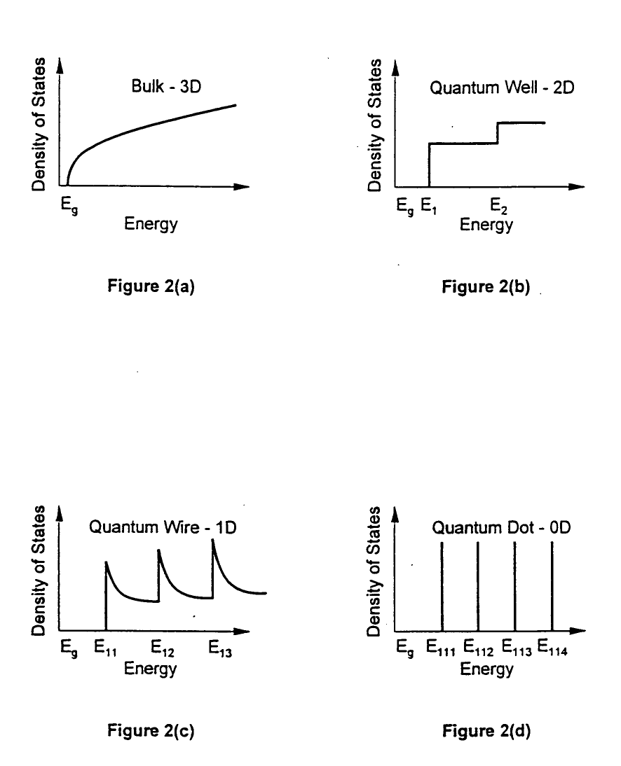

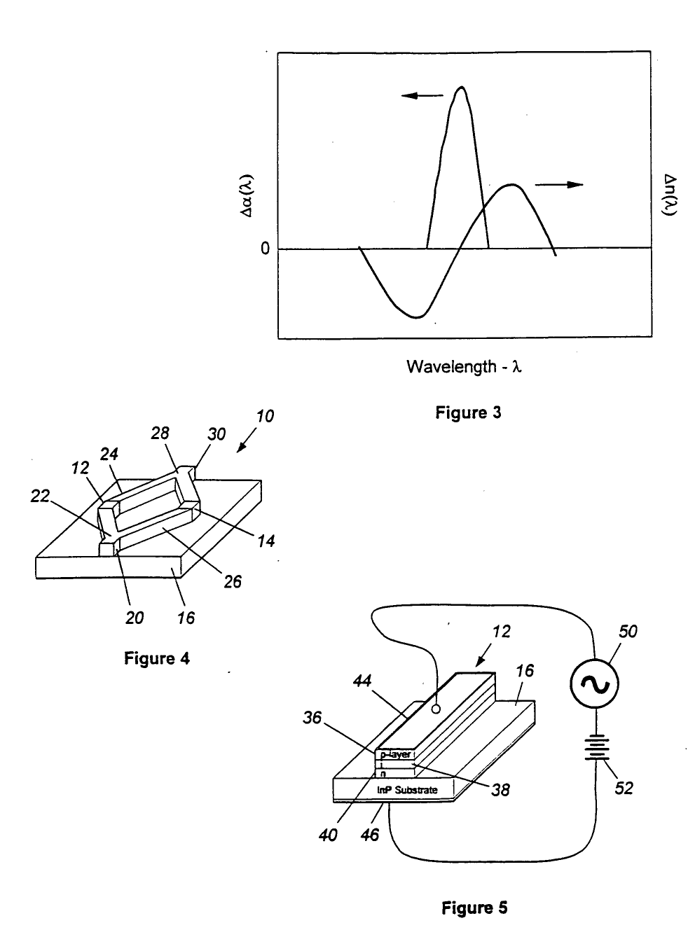

FIG. 2(a)-2(d) show the energy states above the band gap energy E_{g} for each of the bulk semiconductor configuration, the quantum well semiconductor configuration, the quantum wire semiconductor configuration and the quantum dot semiconductor configuration, respectively. As is apparent, electron states are limited to confined and discreet energy levels above the band gap energy E_{g} for quantum dot structures. These quantum dot resonant energy states can be shifted in energy with an applied electric field using the Quantum Confined Stark Effect (QCSE) providing very strong changes in both EA and ER as related through the Kramer-Kronig relationship. FIG. 3 is a graph showing the relationship between the change in absorption Δα due to an implied electric field and the resulting change in refractive index Δn described by the Kramers-Kronig relationship.

The relative strength of the ER using quantum dots can be 50 times that of conventional quantum wells providing a clear path to enhance the modulator efficiency. The quantum dot structures completely eliminate the bulk density of state function that dominates at energies above the lowest bound energy states for bulk, quantum well and quantum wire structures. The quantum dot structure thus allows a strong change in absorption to be created within any associated or residual bulk absorption. Similar to the quantum well case, the QCSE provides a red-shift in the quantum dot energy states with an increasing electric field. Thus, operating at a wavelength slightly red-shifted from the low field, the quantum dot energy level would provide an increase in EA with applied field. Conversely, operating at a wavelength at or slightly blue-shifted from the low field quantum dot energy level would provide a decrease in EA with applied field. The key is that the absorption associated with the bulk material that normally would dominate for energies at or below the lowest bound energy is eliminated in the quantum dot case, and the effective operation at wavelengths below or above the bound energy is possible.

This feature provides the possibility of utilizing both positive and negative structures (EA or ER or both) within the same structure. Implementation of an engineerable structure can utilize epitaxial growth techniques that allow tailoring of the quantum dots, i.e., change of their ground state energy, along an optical modulator to provide both positive and negative changes for a single wavelength within the same device. For example, within an electro-absorption modulator, the effective change in absorption can be tailored to have the functional form of a natural logarithm to linearize the well-known exponential transfer function. Along the same lines, the change in ER can also be tailored and can have different signs for the same operating wavelength. This can be utilized in a Mach-Zehnder modulator configuration where the quantum dots in each arm of the interferometer are matched, but they are tuned separately for the first arm and the second arm. Thus, for a given applied electric field, the first arm implements a positive change in the optical phase and the second arm implements a negative change in the optical phase.

This tuning of the operating point in each arm can be done either with a DC bias voltage to shift one arm relative to the other, or by selective epitaxial growth, where one arm has quantum dots grown to be tuned at the desired shifted wavelength. This configuration enables a simple, single RF drive to implement the push-pull drive configuration without the need to split and phase shift the RF signal 180° between the arms. Also, as in the case of an engineered EA, the shape of the ER versus voltage can be engineered to provide desired functionality. For example, an ER response with an arc cosine function would linearize the well-known raised sinusoid transfer function within a Mach-Zehnder modulator.

A Mach-Zehnder modulator, according to an embodiment of the present invention, will now be described with reference to the figures. FIG. 4 is a perspective view of a PIN semiconductor Mach-Zehnder modulator (MZM) 10 employing tailored quantum dots in the active regions, according to an embodiment of the present invention. The MZM 10 includes a first PIN device 12 and a second PIN device 14 spaced apart from each other and fabricated on a semi-insulating substrate 16. The optical signal to be modulated is applied to an input waveguide 20, such as a fiber optic cable, that is split by a splitter 22 into a first optical arm 24 and a second optical arm 26. The PIN device 12 is positioned within the optical arm 24 and the PIN device 14 is positioned within the optical arm 26, as shown, so that light propagates therethrough. The optical signals propagating through the first and second optical arms 24 and 26 are combined by an optical combiner 28 so that the combined optical signal is output on an output waveguide 30. The combination of the input waveguide 20, the splitter 22, the first and second arms 24 and 26, the combiner 28 and the output waveguide 30 make up a Mach-Zehnder interferometer.

Electrodes, discussed below, are employed to provide an electric field across the PIN devices 12 and 14 so as to provide electro-absorption or electro-refraction in the intrinsic layers within the PIN devices 12 and 14 to absorb more or less light, and/or to speed up or slow down the optical signal propagating therethrough. Thus, when the remaining intensity of the split optical signals are combined in the combiner 28, they will constructively or destructively interfere in a desirable manner to provide beam intensity modulation. The operation of a Mach-Zehnder modulator as described so far is well understood to those skilled in the art.

FIG. 5 is a cross-sectional type view of the PIN device 12 on the substrate 16, and separated from the Mach-Zehnder modulator 10. The PIN device 12 includes a P-type layer 36, an intrinsic layer 38 and an N-type layer 40. The intrinsic layer 38 defines the active waveguide region within the device 12. The PIN device 12 is a conventional semiconductor device, and the substrate 16 and the device layers of the PIN device 12 can be any semiconductor material suitable for the purposes described herein, such as GaAs, InP, etc. However, according to the invention, the intrinsic layer 38 includes a quantum dot structure that allows the PIN device to be tailored for a particular energy density of states to provide a push-pull operation.

A first metal electrode 44 is formed on top of the P-type layer 36 opposite the intrinsic layer 38 and is in electrical contact therewith. A second metal electrode 46 is formed on a surface of the substrate 16 opposite to the device 12, as shown. An RF signal from an RF signal source 50 is applied to the electrodes 44 and 46, and a DC bias voltage is applied to the electrodes 44 and 46 from a DC bias source 52.

The PIN device 14 includes the same configuration as the PIN device 12. However, other configurations of these devices can be provided within the scope of the present invention. For example, the N and P layers can be reversed so that the N-layer is on top and the P-layer is in contact with the substrate 16. Additionally, the electrodes can be configured in various ways as long as an electric field is provided across the intrinsic layer 36. According to one embodiment of the invention, a different DC bias is applied to the PIN devices 12 and 14, and the same RF signal is applied to the PIN devices 12 and 14 in phase with each other. The DC bias applied to the PIN devices 12 and 14 provides a set voltage operating point for that device relative to a particular density of states energy level.

An optical signal to be modulated is input into the input waveguide 20 and is split by the splitter 22. The optical signals propagate through the intrinsic layers of the PIN devices 12 and 14, and are recombined by the recombiner 28 to be output on the output waveguide 30. The DC bias voltage from the DC bias source 52 sets the index of refraction of the intrinsic layers of the devices 12 and 14. The RF signal to be modulated onto the optical signal from the source 50 is applied to the electrodes 44 and 46 to change the index of refraction of the intrinsic layers within the devices 12 and 14 from the set index of refraction. The change in index of refraction in the intrinsic layers from the RF signal causes the optical beam to slow down or speed up, which changes its phase relative to the optical signal in the other arm of the Mach-Zehnder interferometer. In other words, the RF signal from the source 50 affects the DC bias applied to the electrodes 44 and 46 so that a rise in the RF signal level causes the index of refraction of the intrinsic layers in the devices 12 and 14 to move in one direction, and a fall in the RF signal level causes the index of refraction of the intrinsic layers in the devices 12 and 14 to move in an opposite direction.

In a push-pull type MZM, it is desirable to cause the index of refraction of the intrinsic layers of the devices 12 and 14 to move in opposite directions for the same RF signal to increase the relative effect. Therefore, according to the Kramers-Kronig relationship discussed above, the set operating voltage by the DC bias voltage is different for the two PIN devices 12 and 14 so that one of the PIN devices operates at a negative portion of the index of refraction transfer function relative to the optical beam wavelength, and the other PIN device 12 or 14 operates at a positive portion of the index of refraction transfer function relative to the operational wavelength. Thus, for a rise in the RF signal, the index of refraction of one of the intrinsic layers moves in one direction and the index of refraction of the other intrinsic layer moves in an opposite direction, giving the push-pull operation. In other words, the two intrinsic layers can be tuned separately by the DC bias voltages so that for a given applied electric field, one intrinsic layer implements a positive change in optical phase and the other arm implements a negative change in optical phase.

In an alternate embodiment, a selective epitaxial growth of the quantum dot structures in the intrinsic layers is provided so that they behave in an opposite manner to the same DC bias potential. In other words, the quantum dot structures in the intrinsic layers are selectively grown so that the delta energy state for the devices 12 or 14 are at different locations for the same DC bias potential. This allows a positive or negative change from the RF signal to have the same effect in the two arms as described above, but with the same DC operating bias.

As discussed above, providing quantum dots in the intrinsic layers of the devices 12 and 14 provides delta energy states in the intrinsic layers above the band gap energy E_{g}. For a single PIN semiconductor device, such as shown in FIG. 5, quantum dots can be provided to cause the intrinsic layer to be more electro-absorptive or less electro-absorptive in response to the RF signal potential. The delta energy states are the energy levels of the optical signal that will cause the optical signal to be absorbed. The DC bias signal applied to the PIN device 12 sets the operating voltage of the device relative to the frequency of the optical carrier wave propagating through the two arms 24 and 26.

An increase in the bias voltage applied to the one PIN device 12 or 14 decreases the delta energy state and a decrease in the bias voltage increases the delta energy state. Thus, a positive change in the RF signal causes the delta energy state of one device 12 or 14 to move towards the electro-absorption location of the optical wavelength, and causes the delta energy state of the other device 12 or 14 to move away from the electro-absorption location of the optical wavelength. Likewise, a negative change in the RF signal causes the delta energy state of the one device 12 or 14 to move away from the electro-absorption location of optical wavelength and causes the delta energy state of the other device 12 or 14 to move towards the electro-absorption location of the optical wavelength.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

1 . A semiconductor PIN Mach-Zehnder modulator for modulating an optical signal with an RF signal, said optical signal having a carrier frequency, said modulator comprising:
a substrate;
a first PIN device formed on the substrate and including a P-type layer, an intrinsic layer and an N-type layer, said intrinsic layer including a quantum dot structure;
a second PIN device formed on the substrate and including a P-type layer, an intrinsic layer and an N-type layer, said intrinsic layer including a configuration of quantum dot structure;
a Mach-Zehnder interferometer including a first optical path and a second optical path, said intrinsic layer of the first PIN device being positioned in the first optical path and said intrinsic layer of said second PIN device being positioned in the second optical path; and
a biasing system, said biasing system including a first DC bias source applying a first DC bias signal to the intrinsic layer of the first PIN device, a second DC bias source providing a second DC bias signal to the intrinsic layer of the second PIN device, and an RF signal source providing the RF signal in phase to the intrinsic layers of the first and second PIN devices.

2. The modulator according to claim 1 wherein the first and second DC bias sources provide different DC bias signals to the first and second PIN devices.

3. The modulator according to claim 1 wherein the quantum dot structure in the first and second PIN devices are nearly identical.

4. The modulator according to claim 1 wherein the quantum dot structure in the first and second PIN devices are different and the first and second DC bias sources provide the same DC bias to the first and second PIN devices.

5. The modulator according to claim 1 wherein the modulator is an analog modulator that intensity modulates the optical signal with the amplitude of the RF signal.

6. The modulator according to claim 1 wherein the first and second DC bias signals provide an operational energy level on opposite sides of an energy density state of the quantum dot structures.

7. The modulator according to claim 6 wherein the energy density state is determined relative to the carrier frequency of the optical signal.

8. A semiconductor PIN modulator for modulating an optical signal with an RF signal, said optical signal having a carrier frequency, said modulator comprising:
a substrate; and
a first PIN device formed on the substrate and including a P-type layer, and intrinsic layer and an N-type layer, said intrinsic layer including a quantum dot structure.

9. The modulator according to claim 8 further comprising a second PIN device formed on the substrate and including a P-type layer, intrinsic layer and an N-type layer, said intrinsic layer of the second PIN device including a quantum dot structure, said first PIN device being positioned within a first arm of a Mach-Zehnder interferometer and said second PIN device being positioned within a second arm of the Mach-Zehnder interferometer.

10. The modulator according to claim 9 further comprising a biasing system, said biasing system including a first DC bias source applying a first DC bias signal to the intrinsic layer of the first PIN device, a second DC bias source applying a second DC bias signal to the intrinsic layer of the second PIN device, and an RF signal source providing the RF signal in phase to the intrinsic layers of the first and second PIN devices.

11. The modulator according to claim 10 wherein the first and second DC bias sources provide different DC bias signals to the first and second PIN devices.

12. The modulator according to claim 9 wherein the quantum dot structures in the first and second PIN devices are about the same.

13. The modulator according to claim 9 wherein the quantum dot structures in the first and second PIN devices are different and the first and second DC bias sources provide the same DC bias to the first and second PIN devices.

14. A method of modulating an optical signal with an RF signal, said optical signal having a carrier frequency, said method comprising:
providing a first PIN device formed on a substrate, said first PIN device including a P-type layer, an intrinsic layer and an N-type layer, said intrinsic layer including a quantum dot structure;
propagating the optical signal through the first PIN device; and
applying the RF signal to the intrinsic layer of the first PIN device.

15. The method according to claim 14 further comprising providing a second PIN device formed on the substrate, said second PIN device including a P-type layer, and intrinsic layer and an N-type layer, said intrinsic layer of the second PIN device including a quantum dot structure, propagating the optical signal through the second PIN device and applying the RF signal to the intrinsic layer of the second PIN device.

16. The method according to claim 15 further comprising applying a first DC bias potential to the first PIN device and providing a second DC bias signal to the second PIN device.

17. The method according to claim 16 wherein the first and second DC bias signals are different.

18. The method according to claim 15 wherein the quantum dot structures in the first and second PIN devices are nearly identical.
